(19) United States
(12) Patent Application Publication
(10) Pub. No.: US 2026/0359712 A1
(43) Pub. Date: Nov. 12, 2026

(54) Augmenting a Set of Training Examples for Training a Model

(71) Applicant: Microsoft Technology Licensing, LLC, Redmond, WA (US)

(72) Inventors: Xinyu HU, Mountain View, CA (US); Simiao ZUO, Redmond, WA (US); Yeyun GONG, Beijing (CN); Qiang LOU, Sammamish, WA (US); Jian JIAO, Bellevue, WA (US); Denis Xavier CHARLES, Redmond, WA (US); Eren MANAVOGLU, Menlo Park, CA (US)

(73) Assignee: Microsoft Technology Licensing, LLC, Redmond, WA (US)

(21) Appl. No.: 19/201,963

(22) Filed: May 8, 2025

(51) Int. Cl. G06N 20/00; G06F 16/28; G06F 16/953

(52) U.S. Cl. CPC G06N 20/00; G06F 16/285; G06F 16/953

(57) ABSTRACT

A technique for training a machine-trained matching model (“matching model”) includes a multi-stage process for generating training examples. The technique includes: receiving initial pairs of queries and identified items (e.g., identified keywords); annotating the initial pairs with annotations using an annotation computer-implemented agent, to provide annotated pairs; clustering the annotated pairs into categories using a clustering computer-implemented agent; generating additional examples of query-item mismatches based on the categories, using an example-generating computer-implemented agent; and training the matching model based on at least the additional examples. The technique provides a time-efficient and resource-efficient way of assembling a sufficiently large collection of relevant training examples.

### BACKGROUND

A machine-trained model (“model”) is typically trained on a large corpus of training examples. A developer may then periodically re-train the model based on an updated set of training examples. In part, the updated set of training examples is assembled to address perceived weaknesses in an existing version of the model, and to ensure that the model provides accurate responses to the types of queries currently being asked by users. However, it is a challenging task to obtain these updated training examples. A first challenge arises from the difficulty in ensuring that training examples are relevant to the specific objectives for which the model is being re-trained. A second challenge is due to the difficulty of obtaining a sufficiently large number of these training examples. In some cases, large machine-trained models are trained on millions of training examples—or possibly even large corpuses. The task of assembling these examples is often expensive and consumes a significant amount of time, labor, and computational resources.

### SUMMARY

A technique is described herein for training a matching machine-trained matching model (“matching model”). As used herein, in some examples, “training” is meant to encompass an initial stage of training and any subsequent re-training of the matching model. In some implementations, the technique begins by receiving initial pairs of queries and identified items, e.g., submitted by advertisers who offer the pairs as examples of unsatisfactory performance of the matching model. Each initial pair is an example of an error made by a current version of the matching model in matching a particular submitted query with a particular item. The technique then annotates the initial pairs with annotations using an annotation computer-implemented agent, to provide annotated pairs. Each explanation for an initial pair specifies a reason why the pair's query fails to match the pair's identified item. The technique then includes: clustering the annotated pairs into categories using a clustering computer-implemented agent; generating additional examples of query-item mismatches based on the categories, using an example-generating computer-implemented agent; and training the matching model based on at least the additional examples.

In some examples, each identified item is a keyword that is identified in response to a submitted query.

In some examples, the technique also includes identifying, using a re-ranking model, a set of query-item pairs that match for the categories.

In some examples, the computer-implemented agents are one or more machine-trained models, such as one or more language models.

In some examples, the matching model is subsequently used in a search engine to select keywords for submitted queries. In some examples, the search engine generates sponsored search results based on the selected keywords.

In some examples, the matching model includes a retrieval model and a relevance model, both of which are trained in the training operation.

Among other technical benefits, the technique provides a time-efficient and resource-efficient approach to collecting a large number of relevant training examples on which to re-train the matching model. Further, collecting a large and relevant corpus of training examples improves the accuracy and versatility of the matching model which is trained on this corpus.

The above-summarized technology can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an example-generating and training (EGT) system for generating training examples and for re-training a matching model based on the training examples.

FIG. 2 shows one implementation of the EGT system of FIG. 1.

FIG. 3 shows one implementation of the matching model.

FIG. 4 shows an example of query-keyword mismatches identified by a particular advertiser.

FIG. 5 shows an example of annotations produced by an annotation computer-implemented agent used in the EGT system of FIG. 1.

FIG. 6 shows an example of categories identified by a clustering computer-implemented agent, which is another agent used by the EGT system of FIG. 1.

FIG. 7 shows a sample of additional examples generated by an example-generating computer-implemented agent, which is another agent used by the EGT system of FIG. 1.

FIG. 8 shows an example of a re-ranked set of keywords produced by a re-ranking computer-implemented agent, which is another model used by the EGT system of FIG. 1.

FIGS. 9-12 are tables that provide evidence of the superior performance of matching model that is trained using training examples produced the EGT system of FIG. 1 (relative to the performance of a query-keyword matching model that does not benefit from the training examples produced by the EGT system).

FIG. 13 is a flowchart that provides an overview of one manner of operation of the matching model of FIG. 3.

FIG. 14 is a flowchart that provides an overview of one manner of operation of the EGT system of FIG. 1.

FIG. 15 shows an illustrative language model for implementing various functions of the EGT system and the matching model of FIGS. 1 and 3, respectively.

FIG. 16 shows computing equipment that, in some implementations, is used to implement the computing systems of FIGS. 1-3.

FIG. 17 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. EGT System and the Matching Model

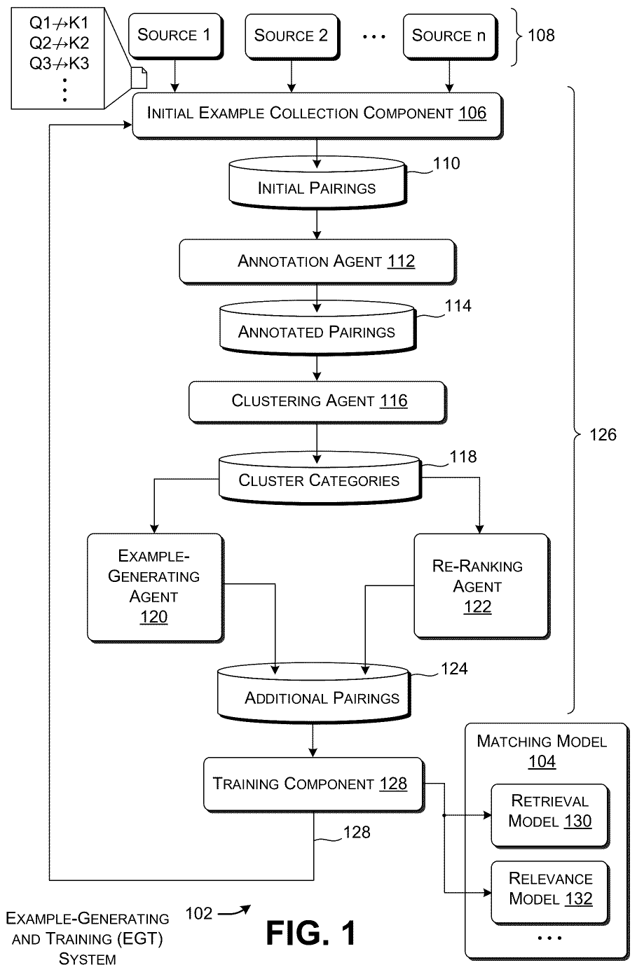

FIG. 1 shows an example-generating and training (EGT) system 102 for generating training examples and for training a machine-trained matching model (“matching model”) 104 based on the training examples. In the principal examples described herein, the examples are used to re-train the matching model 104, and, in some examples, the term “training” is intended to encompass re-training. But the principles described herein could also be used to generate an initial set of training examples for training a newly developed matching model.

The matching model 104 performs the task of matching queries submitted by users to candidate items. Another system then retrieves target output items based on the identified candidate items. The figures will be explained for the more specific example in which a search engine or other document-serving platform implements the matching model 104. In this context, the candidate items are keywords, and the target output items are sponsored search result items. But the principles described herein extend to other interpretations of candidate items and target output items. For example, in another context, the candidate items are document topics, and the target output items are documents that are associated with those topics.

More generally, the following terminology is relevant to some examples presented below. In some examples, a “machine-trained model” or “model” refers to computer-implemented logic for executing a task using machine-trained parameters (e.g., weights and bias parameters) that are produced in a training operation. In some examples, a “token” refers to a unit of information processed by a machine-trained model, such as a word or a part of a word. In some examples, a “prompt” refers to a sequence of tokens submitted to a machine-trained model. In some examples, “distributed vector” expresses the semantic content of an information item by distributing information over its k dimensions. In some examples, terms such as “component,” “module,” “engine,” and “tool” refer to parts of computer-based technology that perform respective functions. FIGS. 14 and 15, described below, provide examples of illustrative computing equipment for performing these functions.

Referring to FIG. 1, a collection component 106 receives an initial set of pairs from one or more sources 108. In the principal example identified above, each pair is an identified query-keyword pair made by the matching model 104 prior to it being re-trained. Each query includes one or more words and/or other linguistic tokens. Likewise, each keyword includes one or more words and/or other linguistic tokens.

For example, consider the illustrative environment in which a source is an entity (e.g., a company) that is sponsoring a marketing campaign. The entity has selected a group of keywords that pertain to its marketing campaign. The entity may interact with the collection component 106 to report queries that are being incorrectly matched with its keywords. These mismatches are undesirable because they cause a search engine to provide sponsored search result items to users who submit those queries, yet the users are unlikely to click on the search result items (e.g., by activating URLs associated with those search results). This is because the search result items do not accurately reflect the search objectives underlying the submitted queries. The entity nevertheless may incur a cost for these non-productive impressions. Each query-keyword pair identified by a source is referred to herein as a DSAT, which is an abbreviation of “dissatisfactory.” A data store 110 stores the set of initial pairs.

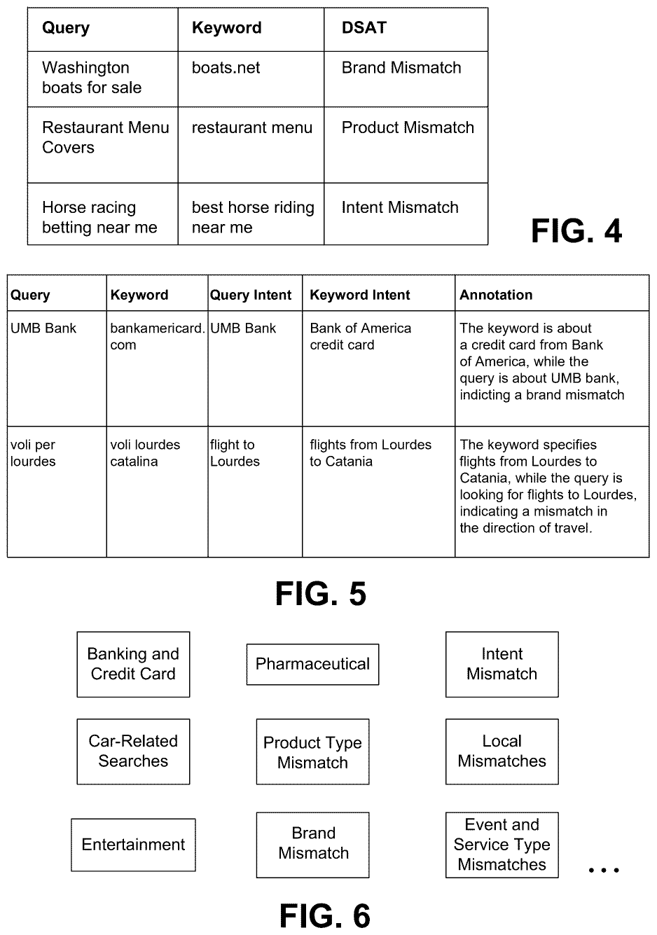

FIG. 4 shows three DSATs. In the second example, for instance, a user has submitted the query “Restaurant Menu Covers.” The matching model 104 in its current state matches this query with the keyword “restaurant menu holders.” This pair is unsatisfactory because the keyword targets a different product than the query, causing the search engine to deliver sponsored search result items with which the user is unlikely to productively engage (because the user's search objective is to explore restaurant menu covers, not menu holders).

An annotation agent 112 is computer-implemented functionality that annotates each initial pair with an explanation. The explanation specifies a reason which underlies why an initial pair would be considered unsatisfactory. For example, FIG. 5 shows two annotated pairs. In the first pair, a user has entered the query “UMB Bank,” and the matching model 104 has identified the keyword “bankamericard.com.” The annotation agent 112 diagnoses this initial pair as a brand mismatch, and adds the annotation: “The keyword is about a credit card from Bank of America, while the query is about UMB bank, indicating a brand mismatch.” A data store 114 stores a set of annotated pairs.

A clustering agent 116 is computer-implemented functionality that groups the annotated pair into categories. A data store 118 stores information regarding the identified categories. Membership of a pair in a cluster indicates that the pair is an example of the category of mismatches associated with the cluster. For example, FIG. 6 shows a set of categories identified by the clustering agent 116 for a particular set of annotated pairs. The categories include, for example, “Brand Type Mismatch” to indicate that the query and keyword target different brands, “Product Type Mismatch” to indicate that the query and keyword target different products, “Intent Mismatch” to indicate that the query and keyword target different intents (e.g., search objectives), and so on. Other categories more generally identify topics in which mismatches are being observed, such as “Car-Related Searches” and “Entertainment.” Although not shown, the clustering agent 116 can provide text that provides an explanation of the basis underlying each category.

In some examples, all of the mismatches are the consequence of the failure of the matching model 104, in its current state, to correctly interpret entities in the queries and keywords. In the case of a brand mismatch, for example, the matching model 104 incorrectly interprets the brand specified in a query and/or candidate keyword with which it is paired. An entity generally refers to a specific person, product, brand, object, service, location, event, status, concept, etc. mentioned in a query or a keyword—in other words, a “thing,” often a noun, mentioned in a query or keyword.

An example-generating agent 120 is computer-implemented functionality that generates additional pairs of queries and keywords that conform to the categories identified by the clustering agent 116. The example-generating agent 120 can also be instructed to select diverse additional pairs, e.g., by selecting a subset of new pairs for each category. More specifically, in some implementations, the example-generating agent 120 receives a batch of queries, e.g., corresponding to the queries of existing DSATs. The example-generating agent 120 generates new query-keyword pairs from these queries that conform to the categories identified by the clustering agent 116.

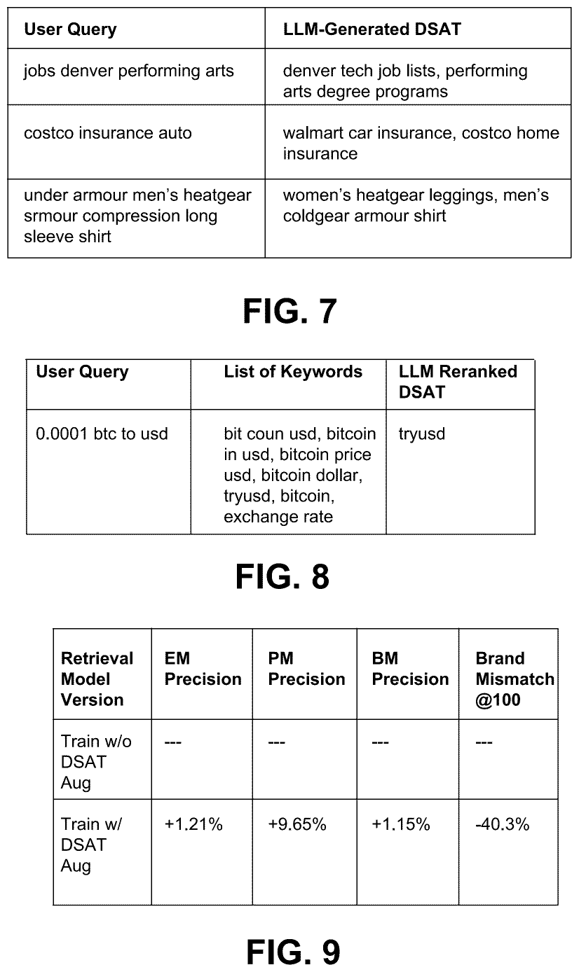

FIG. 7 shows illustrative additional pairs identified by the example-generating agent 120. The second entry in that table, for example, includes a query that reads “costco insurance auto,” a first keyword that reads “walmart car insurance,” and a second keyword that reads “costco home insurance.” The first keyword is erroneous because it creates a brand mismatch. The second keyword is incorrect because it creates a product mismatch.

A re-ranking agent 122 is computer-implemented functionality that identifies additional pairs in a different way compared to the example-generating agent 120. That is, the re-ranking agent 122 instructs the matching model 104 to generate a set of keywords for each query identified in the initial pairs. Alternatively, or in addition, the re-ranking agent 122 chooses query-keyword pairs that originate from some other source, such as query log or an index. The re-ranking agent 122 then identifies, for each subset of query-keyword pairs, the pair or pairs (if any) that conform to the categories identified by the clustering agent 116. In some implementations, the re-ranking agent 122 performs this task using a binary classifier that classifies each pair as a DSAT or not, or a multi-class classifier that identifies the category to which each pair belongs. These examples constitute another set of additional pairs. A data store 124 stores the complete set of additional pairs, which can include several million additional pairs.

In the example of FIG. 8, for instance, the query is “0.0001 btc to usd.” The intent underlying the query is to discover how much 0.0001 bitcoin is worth in U.S. dollars. All of the keywords identified by the matching model 104 are relevant, except for “tryusd.” This keyword targets general interest in the U.S. dollar, but fails to specifically focus on the conversion rate between bitcoin and the U.S. dollar. It therefore evinces a product mismatch and/or an intent mismatch.

The above operations are collectively performed by an example-generating system 126. The example-generating system 126 is technically beneficial because it provides a mechanism for quickly and automatically generating a large number of relevant additional pairs for use in training (to be described next). This task is difficult without the assistance of the example-generating system 126 because it may be challenging for a user to understand the patterns underlying the DSATs. It is further challenging for a user to manually create a sufficient number of these pairs for use in training.

In a training phase, a training component 128 generates a set of training examples based on the additional pairs in the data store 124. That is, each training example specifies a query and a keyword identified by either the example-generating agent 120 or the re-ranking agent 122. The training component 128 then retrains the matching model 104 based a corpus of training examples that include the additional examples. When training is complete, the updated matching model 104 will be better able to exclude pairs that match the categories identified by the clustering agent 116. This improvement, in turn, will reduce the number of unproductive sponsored search results being sent to users. More generally stated, the EGT system's ability to collect a large and relevant corpus of training examples improves the accuracy and versatility of the matching model 104 which is trained on this corpus.

Improving the matching model 104 has benefits that are manifested across different dimensions. First, improving the matching model 104 reduces the waste of resources, e.g., corresponding to the communication, processor, and memory resources involved in generating and serving unproductive sponsored search results. Second, the improvement increases the conversion rate of an advertiser's keywords and reduces costs spent on non-productive query-keyword matches. Third, the improvement reduces irrelevant clutter presented on user interface presentations. This enables efficient interaction with the user interface presentations.

In some implementations, the matching model 104 includes a set of models. For instance, a retrieval model 130 identifies a set of candidate keywords for a query that has been submitted. A relevance model 132 filters the set of query-keyword pairs identified by the retrieval model 130, with the objective of removing or demoting erroneous pairs. The training component 128 trains both of these models (130, 132). More specifically, in re-training the retrieval model 130, the training component 128 treats the additional examples as hard negatives. When re-training the relevance model 132, the training component 128 treats the additional examples as negatives. A negative is an example of an erroneous pairing of a query and a keyword. A hard negative is an example of an erroneous pairing that is more difficult for the matching model 104 to identify than a regular negative, and is therefore “hard.” It is desirable use hard training examples in training because it more effectively forces the matching model 104 to learn the true patterns underlying the DSAT categories. With respect to easy negatives, there is a risk that the matching model 104 learns superficial patterns, not the actual reasons underlying the DSAT categories.

Altogether, the EGT system 102 generates additional training examples and performs training based on those training examples. The loop 134 indicates that the EGT system 102 can repeat the above-described process on a periodic or demand-driven basis as additional subsets of erroneous query-keyword pairs are received from the sources 108. For example, the EGT system 102 can repeat the process on a monthly basis.

In some implementations, the clustering agent 116 is implemented, at least in part, by a language model. By way of overview, the language model iteratively forms soft clusters of annotated pairs, merges them progressively, and continues the process until convergence. Ultimately, the clustering agent 116 associates each cluster with a specific mismatch category.

More specifically, in some implementations, the clustering agent 116 operates on batches of annotated pairs (e.g., on batches of 100 annotated pairs), each including a particular query, a particular keyword, and a particular annotation (if provided). For a first batch, the EGT system 102 sends a prompt to the language model that requests the language model to group the annotated pairs in the first batch into soft clusters, given a taxonomy. The taxonomy provides definitions of entity types and mismatch categories, which serve to guide the language model's clustering decisions. An illustrative taxonomy might have information such as, “Location mismatch: discrepancies in place names, coordinates, etc.; Person mismatch: discrepancies in names, roles,” and so on.

Consider, for instance, an example in which an annotated pair includes a label that specifies a mismatch type. The language model will use this given label to group the annotated pair into a cluster associated with that mismatch type. This means, for instance, that the language will generally group all annotated pairs that have the explicit label “location mismatch” with a cluster associated with a location mismatch.

Consider an example in which a pair lacks an explicit label that identifies its mismatch type. The language model will infer the mismatch type by analyzing the query-keyword pair's content, as informed by the given taxonomy. For example, the language model might classify the query “Where is Paris?” and the keyword “Texas” as a location mismatch based on this content itself, as informed by the given taxonomy of entities and mismatch types.

Any single annotated pair can belong to different clusters with different degrees of confidence. For example, the language model might assign a pair that is explicitly annotated as a “location mismatch” to a location mismatch cluster with an 80% confidence level, and to a general mismatch cluster with a 20% confidence level. In this sense, an annotated pair's assignment to a particular cluster is considered soft, and each cluster itself is considered soft. The language model performs this type of probabilistic assignment by computing a probability distribution for each annotated pair over a current set of clusters, reflecting the likelihood it belongs to each of the clusters. The language model normalizes the probabilities such that, for any given annotated pair, the probabilities across different given clusters sum to 1.0.

For each subsequent batch (e.g., of a next 100 annotated pairs), the EGT system 102 sends a prompt to the language model that specifies the new batch of annotated pairs, information regarding the existing soft clusters generated in prior iterations, and the taxonomy. The EGT system 102 instructs the language model to perform the following main tasks: 1) generate new soft clusters for the new annotated pairs based on their entity mismatch types, as defined in the provided taxonomy; 2) assign each new annotated pair a probability distribution over the new and existing soft clusters; 3) merge soft clusters if they represent the same or overlapping entity mismatch types; and 4) update the overall cluster structure and membership probabilities for all annotated pairs. The EGT system 102 continues this process until the number of clusters stabilizes, meaning that further iterations do not significantly alter a generated cluster structure (e.g., by producing new clusters and/or altering membership of annotated pairs among existing clusters).

The language model performs tasks (1) and (2) in the same manner explained above for the initial cluster. With respect to the merging operation of task (3), the language model determines that two candidate soft clusters should be merged based on one or more considerations, three of which are identified below as merge bases A, B, and C.

Merge basis A. Based on an annotation overlap rule, the language model compares the labels associated with the two clusters. The language model merges the two clusters if they have identical or closely related mismatch labels (per the taxonomy).

Merge basis B. Based on a taxonomy-based relationship rule, the language model will determine if the taxonomy defines one cluster's mismatch category as a subset of the other cluster's mismatch category. If so, the language model will merge the two clusters, such that the more specific category is now subsumed in the more general category. For example, assume that the taxonomy identifies “city mismatch” as a sub-category of “location mismatch.” Guided by this relationship, the language model will merge the city mismatch cluster into the location mismatch cluster. Based on a similar logic, the language model may merge a “person name mismatch” cluster into a “person mismatch” cluster.

Merge basis C. Based on a semantic similarity rule, the language model will merge two clusters together upon determining that there is a prescribed degree of semantic similarity between the descriptions of the two clusters. In some cases, the language model reaches this conclusion independent of the rules described above. For example, the language model may determine that a cluster associated with “city mismatch” and a cluster associated with “country mismatch” both pertain to “location mismatch.”

In the merging process itself, the language model combines the annotated pairs from both clusters into a single cluster, and updates the membership probabilities for each pair. If one cluster is a subset of the other cluster, the cluster having a broader scope will absorb the cluster having the more narrow scope (e.g., such that a “location mismatch” cluster will absorb a “city mismatch” category).

With respect to task (4), the language model recomputes the soft membership of each annotated pair across the new cluster structure, after the above-described merging process. Again, for any given annotated pair, the sum of its membership probabilities sums to 1.0.

In some implementations, the clustering agent 116 uses one or more approaches to validate a cluster structure that is formed in the above manner. In a first approach, the clustering agent 116 encodes each query-keyword pair (and/or its annotation) of a cluster under consideration into an embedding (e.g., a distributed vector) using a language model (e.g., a BERT-type transformer model) or any other type of encoding model. The clustering agent 116 then computes a cosine similarity score between every pair of embeddings associated with the cluster under consideration. For example, if there are three pairs (A, B, C) in a cluster having respective embeddings, the clustering system 116 computes the cosine similarity between the embeddings for pairs A and B, pairs A and C, and pairs B and C. The clustering agent 116 then computes the average (or any other summarization score) of the cosine similarity scores. Higher average similarity scores are indicative of more cohesive clusters. Such a cluster is likely to include annotated pairs that share similar entity mismatches.

In another approach, the EGT system 102 randomly samples query-keyword pairs from a cluster (e.g., 10 pairs). The EGT system 102 asks a language model to determine if any of these sampled pairs are misclustered, meaning that they do not semantically belong in this cluster's mismatch category (e.g., as defined by the description provided in the taxonomy). The EGT system 102 scores the validity of the cluster based on its overall error rate, e.g., as measured by a percentage of misclustered pairs. Clusters will lower error rates have better clustering qualities.

The above-described piecemeal derivation of soft clusters is technically advantageous because it reduces the computational load placed on the clustering agent 116 with respect to each batch of training examples, while ensuring high quality clustering results. The processing of batches of annotated pairs also reduces the amount of tokens that are passed to a language model in any given submission.

Other implementations use other types of clustering to generate the clusters. Illustrative alternative clustering techniques include k-means clustering, agglomerative (hierarchical) clustering, density-based clustering, etc.

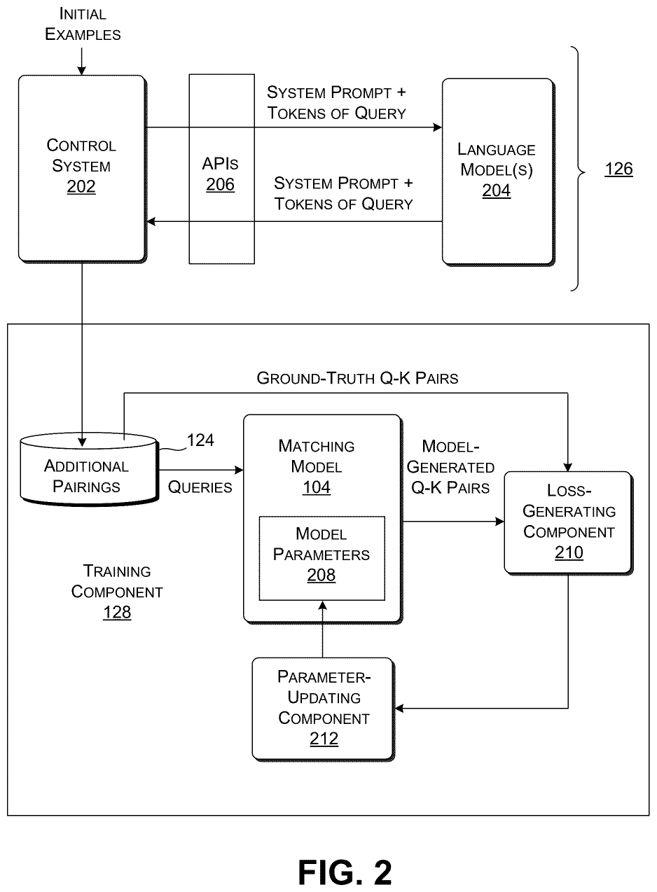

FIG. 2 shows one implementation of the EGT system of FIG. 1. Referring first to the example-generating system 126, a control system 202 interacts with one or more language models 204 via one or more application programming interfaces (APIs) 206.

In some implementations, the language model(s) 204 implement all of the agents, including the annotation agent 112, the clustering agent 116, the example-generating agent 120, and the re-ranking agent 122. In a first implementation, for instance, the language model(s) 204 is a single large language model that is configured to perform different tasks based on the instructions given to it. In some examples, the language model receives the instructions via a system prompt. The system prompt specifies: (a) the type of input information that will be sent to the language model, (b) how the language model is to process the input information, and (c) the manner in which the language model is to format its output results. The system prompt may also include one or more examples that instruct the language model how to correctly perform the task. The language model(s) 204 combines the tokens associated with the system prompt with other tokens associated with a specific instance of input information. For example, with respect to the annotation agent 112, the input information includes tokens that make up the initial pairs. With respect to the clustering agent 116, the input information includes tokens that make up the annotated pairs, the tokens that make up the taxonomy, tokens that describe prior-generated soft clusters, and so on.

In other examples, the language model(s) 204 include one or more languages models that have been fine-tuned to perform specific tasks. For example, a first language model is fine-tuned to operate as the augmentation agent, and a second language model is fine-tuned to operate as the clustering agent 116, and so on.

One example of a publicly available pre-trained language model that is capable of serving as a general purpose or special purpose language model is described in Touvron, et al., “LLaMA: Open and Efficient Foundation Language Models,” arXiv, arXiv:2302.13971v1 [cs.CL], Feb. 27, 2023, 27 pages. Another example is described in Jiang, et al., “Mistral 7B,” arXiv:2310.06825v1 [cs.CL], Oct. 10, 2023, 9 pages. In other examples, a commercially available language model, such as any member of the GPT family of language models available from OpenAI of San Francisco, California, can be used to provide a general-purpose language model.

In other examples, any of the agents is implemented by a different type of neural network, such as a convolutional neural network or a recurrent neural network. Alternatively, or in addition, any of the agents is implemented using a rules-based system. For example, the annotation agent 112 can implement its tasks based on a set of discrete rules. Some rules are predicated on the detection of a keyword in a predetermined list of keywords. One rule, for instance, specifies that if a query includes keyword X and the keyword includes keyword Y, then a mismatch has occurred indicative of category Z (where X, Y, and Z are generic placeholders for specific linguistic values).

Each API specifies an interface by which information is exchanged between the control system 202 and the language model(s) 204. For example, each API describes types of information items that can be passed from the control system 202 to the language model(s) 204, and vice versa.

FIG. 2 also shows one implementation of the training component 128. The training component 128 operates on a set of training examples, which include, at least in part, the additional examples derived from the additional pairs produced by the example-generating system 126. The keywords associated with the training examples constitute ground-truth keywords. For the purpose of training the retrieval model 130, the query-keyword pairs of the additional examples constitute hard negatives. For the purpose of training the relevance model 132, the query-keyword pairs of the additional examples constitute negative examples.

The training component 128 passes the queries associated with a set of training examples to the matching model 104. The matching model 104 has a current set of trainable parameters 208. The matching model 104 uses its models (e.g., the retrieval model 130 and the relevance model 132) to produce model-generating keywords for the queries that have been fed to it. More specifically, for each input query, the matching model 104 generates a distribution of probabilities over different candidate keywords.

A loss-generating component 210 generates a loss measure by comparing the model-generated keyword probability distributions with the ground-truth keywords associated with the added training examples. More specifically, the loss-generating component 210 generates a measure of loss using a contrastive loss function with respect to the retrieval model 130. A contrastive loss function attempts to push the queries and keywords of positive examples closer together in vector space, and attempts to push the queries and keywords of negative examples farther apart in the vector space. For example, if a negative training example specifies that a keyword Y is an invalid match for a query X, then the training component 128 will attempt to reduce the probability that keyword Y is selected given query X. The loss-generating component 210 generates a measure of loss using cross-entropy with respect to the relevance model 132.

A parameter-updating component 212 updates the model parameters 208 based on the loss information computed by the loss-generating component 210. In some implementations, the parameter-updating component 212 performs this task using stochastic gradient descent in combination with back propagation. Back propagation updates the parameters of each layer of the matching model 104 in succession, starting with a topmost layer and advancing to the lowest layer of the matching model (where the lowest level receives the input information, and the topmost layer provides hidden state information associated with the output results). More specifically, the parameter-updating component 212 uses the loss information computed for the retrieval model 130 to update the parameters of the retrieval model 130 and uses the loss information computed for the relevance model 132 to update the parameters of the relevance model 132.

Although not shown in FIG. 2, the training component 128 can repeat the above-described process for plural batches and for plural epochs until a training goal is obtained. The training goal may be a prescribed number of iterations or the attainment of a target level of performance as measured by any performance metric(s).

Alternatively, or in addition, other implementations apply other kinds of training. For example, another type of training uses reward-based training to update the parameters of the matching model 104 (such as Proximal Policy Optimization (PPO) or Direct Preference Optimization (DPO)).

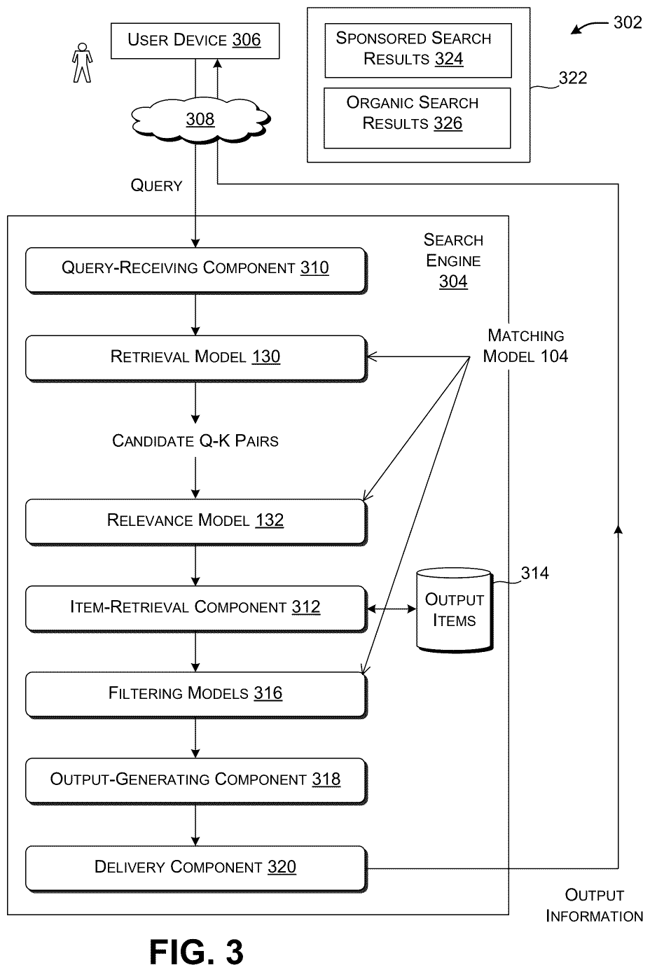

FIG. 3 shows one implementation of a data processing environment 302 that uses the matching model 104. In one illustrative context, a search engine 304 uses the matching model 104 to match a submitted query with a set of zero, one, or more candidate keywords. The search engine 304 then selects a set of target output items associated with the candidate keyword(s). The search engine 304 then generates and provides output information that identifies the target output items. In some illustrative contexts, the target output items are sponsored search results items. Each such search result item identifies a product, service, or other objective being promoted by a particular entity. The search engine 304 generates output information that includes the sponsored search result items and optionally a set of organic search result items. Each organic search result item is selected because it is determined to match the submitted query independent of any marketing objective of any sponsor. The search engine 304 determines an organic match based on any matching criteria, including any semantic, lexical, and/or contextual factors.

More specifically, in some implementations, a user device 306 receives a query from a user. For example, the user device 306 is a user computing device of any type that interacts with the search engine 304 via a browser application program implemented by the user device 306. In some implementations, the user device 306 and the search engine 304 are provided at separate locations, and the user device 306 interacts with the search engine 304 via a computer network 308 of any type, such as the Internet. In other examples, the user device 306 and the search engine 304 are co-located. For example, the search engine 304 may represent an application that is locally running on the user device 306, in whole or in part.

The search engine 304 includes a query-receiving component 310 for receiving the user's submitted query. The retrieval model 130 (described above) then matches the query with zero, one, or more candidate keywords, to produce zero, one, or more candidate query-keyword pairs. The relevance model 132 filters the set of candidate query-candidate pairs, e.g., by removing or demoting pairs that are incorrect or non-preferred, where the criteria that is used to make this determination is learned by the relevance model 132 based on its training (as described above with respect to FIG. 2).

An item-retrieval component 312 uses each candidate keyword as a lookup key to find the target output item(s) (e.g., one or more sponsored search result items) that have been previously associated with the keyword. In some implementations, a data store 314 stores a lookup table that identifies the association between candidate keywords and target output items. In the context of sponsored search, a target output item is a content item or a reference to the content item. For example, a target output item is a reference to a website associated with an entity that is sponsoring a marketing campaign. Each sponsored search result item of this type may include a title, URL link, and body.

In some implementations, the matching model 104 includes the retrieval model 130, the relevance model 132, and one or more other filtering model(s) 316 that perform additional filtering of the selected target output items. For example, one other filtering model may reject any query-keyword pair that is associated with a target output item having a title that is not semantically related to the topic of the query. However, in some implementations, the training component 128 does not use the additional training examples that it generates to update the parameters of these later-stage filtering models. That is, the training component 128 only updates the subset of models devoted to selecting and filtering query-keyword pairs.

An output-generating component 318 produces output information that includes the identified target output items. As described above, in some contexts, the output information is user interface presentation information that includes a set of sponsored search result items and, optionally, a set of organic search result items. A delivery component 320 sends the output information to the user device 306 via the computer network 308. In some implementations, the user device presents the output information in a search results page 322 that includes a first set of entries 324 associated with the sponsored search result items and a second set of entries 326 associated with the organic search result items. Each entry, for instance, is a snippet that provides a URL, a portion of a title, and a portion of a body associated with a search result item. A user may interact with any search result item by hovering over it or clicking on it, which will direct the user to the website or other content item associated with the search result item's URL link.

In other examples, instead of, or in addition to, sponsored search result items, the search engine 304 identifies and serves digital advertisements and/or other content items based on the identified query-keyword pairs.

### B. Performance of the EGT System

FIGS. 9-12 are charts that provide evidence of the improved performance of a matching model 104 trained in based on a corpus that includes the additional training examples produced by the example-generating system 126, compared to a matching model that is not trained based on the additional examples.

In FIG. 9, a chart shows the precision of the retrieval model 130 for the case of training with DSAT augmentation (in the first row) and training without DSAT augmentation (in the second row). In some examples, precision refers to the percentage of relevant search result items in a set of search result items. “EM,” “PM,” and “BM” represent different categories of matches (“exact,” “phrase,” and “broad”) having different criteria for what constitutes a match, “exact” requiring the highest level of overlap. More specifically, two items are an exact match when they use the same wording, with minor permitted variation (e.g., such that “shoe” might match “shoes”). Two items are a phrase match when some parts of the two items match and other portions do not match (e.g., such that “buy shoes” might match “shop for shoes”). Two items are a broad match when they have related meanings (e.g., such that “shoe” might match “boot”). An entity is described earlier as a particular thing (person, brand, object, concept, etc.) mentioned in an item. As indicated in this chart, the use of additional examples produced by the example-generating system 126 improves the precision of the relevance model 130. The last column identifies the percentage of search result items that result from brand mismatches in query-keyword pairs. As indicted in the chart, the use of the additional examples produced by the example-generating system 126 reduces the percentage of brand mismatches by a sizable amount (+40%).

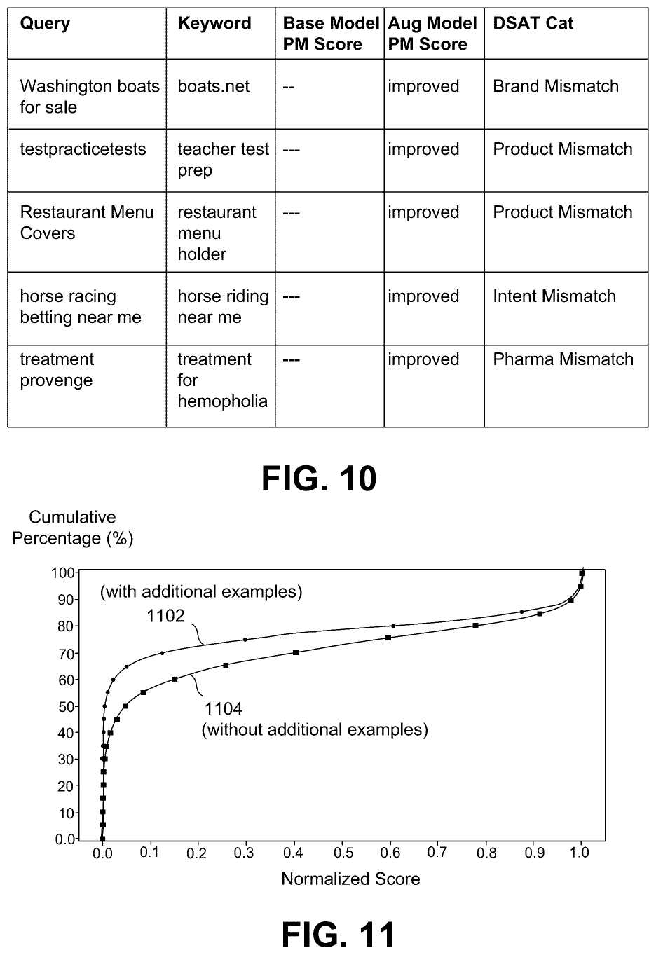

FIG. 10 shows the performance of the retrieval model 130 for specific submitted queries. More specifically, the first column identifies a submitted query. The second column identifies a candidate keyword that has been paired with the query by the matching model 104. A third column identifies the score of the pair without the use of the additional examples produced by the example-generating system 126. The fourth column identifies the relative score of the pair with the inclusion of the additional examples (e.g., indicating whether it improves detection of the DSAT category relative to the base case of the third column). The fifth column identifies the category of mismatch associated with the query-keyword pair. Consider, for example, the third row of this table. The table shows that the query-keyword pair is indictive of a product mismatch. The use of the additional examples reduces the score, which has the effect of reducing the desirability of this query-keyword pair by a corresponding amount (and possibly resulting in the non-selection of this query-keyword pair).

FIG. 11 shows the performance of the relevance model 132 for the case in which the additional examples produced by the example-generating system 126 are included (in distribution 1102) and for the case in which they are not included (in distribution 1104). That is, each distribution shows the cumulative percentage of detected DSAT categories with respect to normalized scores. A comparison between the two distributions (1102, 1104) indicates that the inclusion of the additional examples enables the relevance model 132 to identify a greater number of DSAT patterns across different normalized scores.

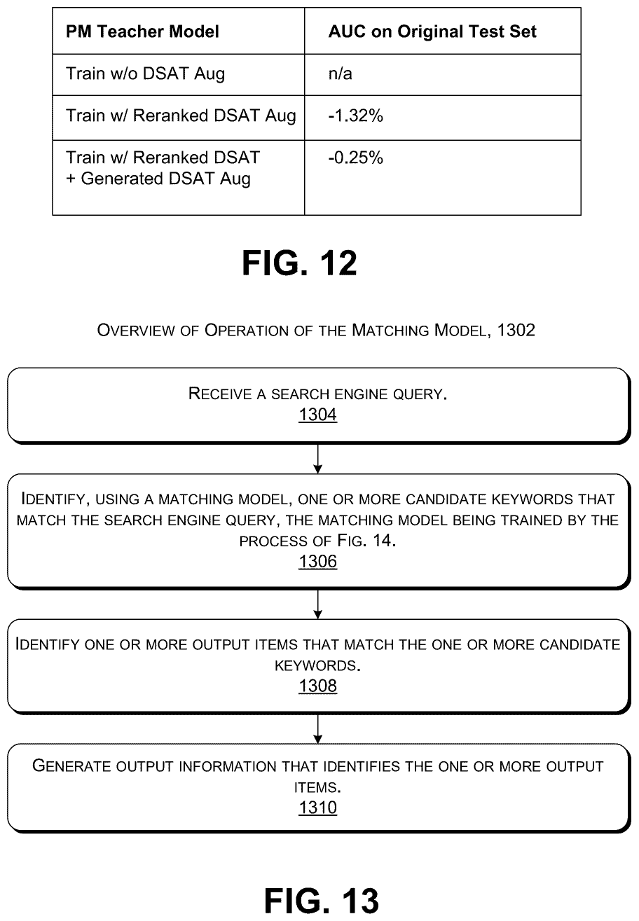

FIG. 12 shows the AUC (area under curve) score for three different cases, with respect to the performance of the original set of training examples. (The original set of training examples is the set on which the matching model 104 was originally trained.) A first row of FIG. 12 shows the performance with respect to the original set after training without the inclusion of additional examples. A second row shows the performance with respect to the original set after re-training the relevance model 132, but without the benefit of the additional examples produced by the example-generating agent 120. A third row shows the performance with respect to the original set after training with the additional examples produced using the example-generating agent 120 and using a re-trained relevance model 132. The chart indicates that the use of augmented examples does not markedly worsen the matching model's performance with respect to the original set of training examples. That is, although the training allows the matching model 104 to more correctly identify and exclude the categories of mismatch identified by the clustering agent 116, it does not otherwise disrupt the ability of the matching model 104 to correctly interpret the existing categories of mismatch present in the original set of training examples.

### C. Illustrative Processes

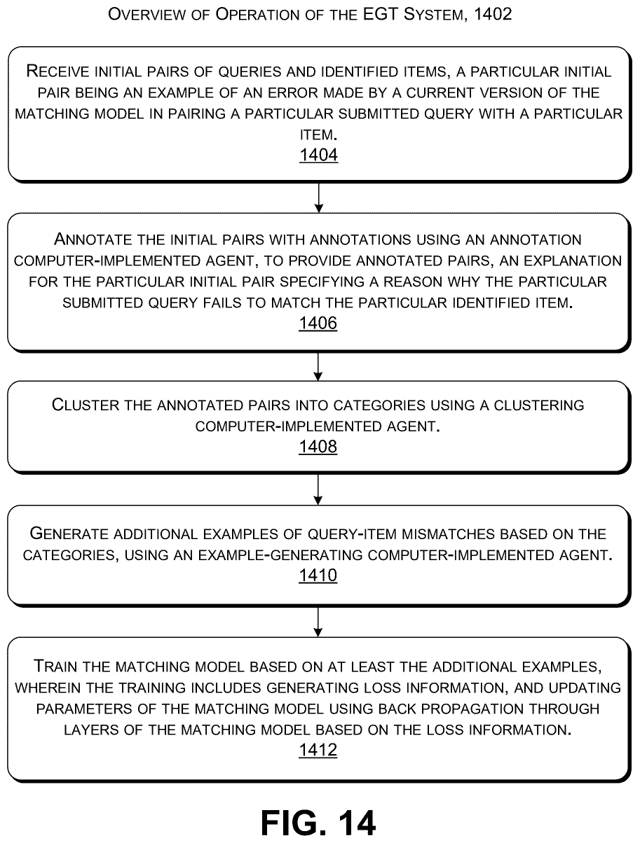

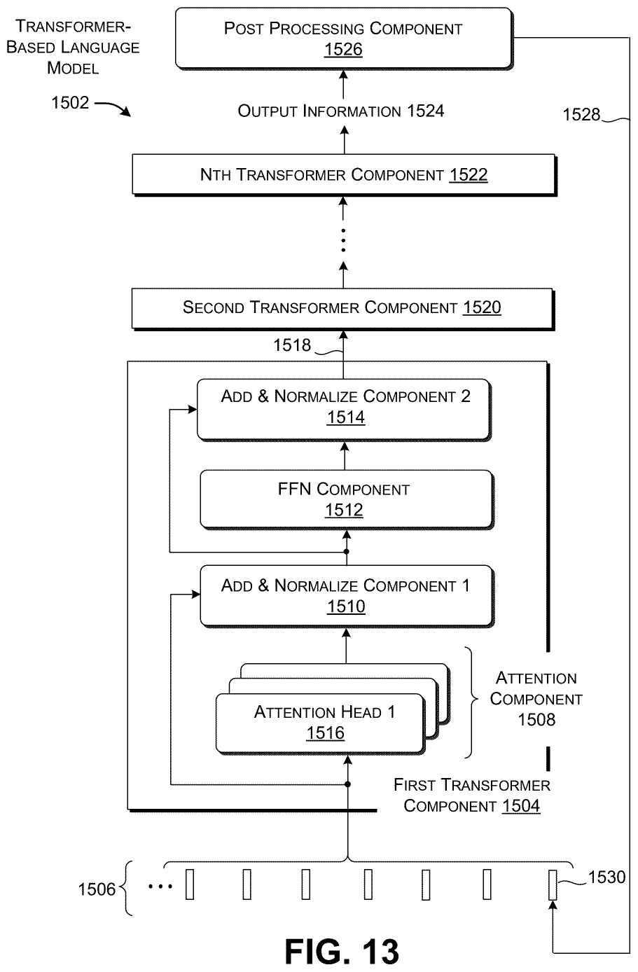

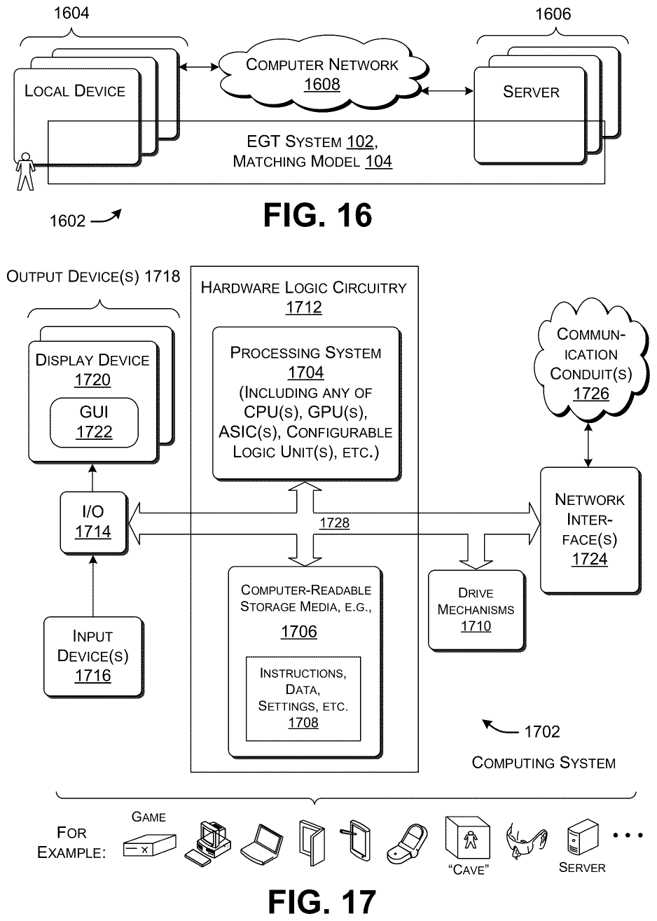

FIGS. 13 and 14 show two processes that represent an overview of the operation of the computing systems of Section A. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 15 and 16.

FIG. 13 is a process 1302 that shows one manner of operation of the matching model 104 of FIG. 3. In block 1304, the search engine 304 or other matching platform receives a search engine query. In block 1306, the search engine 304 identifies, using the trained matching model 104, one or more candidate keywords that match the search engine query. In block 1308, the search engine 304 identifies one or more output items (e.g., search result items) that match the one or more candidate keywords. In block 1310, the search engine 304 generates output information that identifies the one or more output items.

FIG. 14 is a process 1402 for training the matching model 104. In block 1404, the EGT system 102 receives initial pairs of queries and identified items. A particular initial pair is an example of an error made by a current version of the matching model in pairing a particular submitted query with a particular item. In block 1406, the EGT system 102 annotates the initial pairs with annotations using an annotation agent 112, to provide annotated pairs. An annotation for the particular initial pair specifies a reason why the particular submitted query fails to match the particular identified item. In block 1408, the EGT system 102 clusters the annotated pairs into categories using a clustering computer-implemented agent 116. In block 1410, the EGT system 102 generates additional examples of query-item mismatches based on the categories, using an example-generating computer-implemented agent 120. In block 1412, the EGT system 102 trains the matching model 104 based on at least the additional examples. The training includes generating loss information, and updating parameters of the matching model using back propagation through layers of the matching model based on the loss information.

### D. Illustrative Language Model

FIG. 15 shows a transformer-based language model (“language model”) 1502 for implementing one or more of the computer-implemented agents. In some implementations, the language model 1502 operates in an autoregressive manner when applied to the computer-implemented agents. In this role, the purpose of the language model 1502 is to perform different tasks in the production of additional training examples. In addition, the language model 1502 can be used to implement the retrieval model 150 and/or the relevance model 152 of the matching model 104. In this role, the operates as a classifier that maps input information to a classification result in a single pass (that is, non-autoregressively).

The language model 1502 is composed, in part, of a pipeline of transformer components, including a first transformer component 1504. FIG. 15 provides details regarding one way to implement the first transformer component 1504. Although not specifically illustrated, other transformer components of the language model 1502 have the same architecture and perform the same functions as the first transformer component 1504 (but are governed by separate sets of parameters).

The language model 1502 commences its operation with the receipt of input information, such as a set if initial pairs, or a set of annotated parings, or a set of clusters, etc. The model 1502 uses a tokenizer to break the input information into tokens, e.g., byte pair encoding (BPE), a character n-gram, a word fragment identified by the WordPiece or SentencePiece algorithm.

Next, an embedding component (not shown) maps the sequence of tokens into respective token embeddings. For example, the embedding component produces one-hot vectors that describe the tokens, and then maps the one-hot vectors into the token embeddings using a machine-trained linear transformation. The embedding component then adds position information (and, in some cases, segment information) to the respective token embeddings to produce position-supplemented embedding vectors 1506. The position information added to each token embedding describes the embedding vector's position in the sequence of token embeddings.

The first transformer component 1504 operates on the position-supplemented embedding vectors 1506. In some implementations, the first transformer component 1504 includes, in order, an attention component 1508, a first add-and-normalize component 1510, a feed-forward neural network (FFN) component 1512, and a second add-and-normalize component 1514.

The attention component 1508 determines how much emphasis should be placed on parts of input information when interpreting other parts of the input information. Consider, for example, a sentence that reads: “I asked the professor a question, but he could not answer it.” When interpreting the word “it,” the attention component 1508 will determine how much weight or emphasis should be placed on each of the words of the sentence. The attention component 1508 will find that the word “question” is most significant.

The attention component 1508 performs attention analysis using the following equation:

$$Attention ( Q , K , V ) = softmax ( \frac{{QK}^{T}}{\sqrt{{d}_{k}}} ) V . \qquad ( 1 )$$

The attention component 1508 produces query information Q by multiplying the position-supplemented embedding vectors 1506 by a query weighting matrix W^{Q}. Similarly, the attention component 1508 produces key information K and value information V by multiplying the position-supplemented embedding vectors 1506 by a key weighting matrix W^{K} and a value weighting matrix W^{V}, respectively. To execute Equation (1), the attention component 1508 takes the dot product of Q with the transpose of K, and then divides the dot product by a scaling factor \sqrt{d}, to produce a scaled result. The symbol d represents the dimensionality of Q and K. The attention component 1508 takes the Softmax (normalized exponential function) of the scaled result, and then multiplies the result of the Softmax operation by V, to produce attention output information. In some cases, the attention component 1508 is said to perform masked attention insofar as the attention component 1508 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 15 shows that the attention component 1508 is composed of plural attention heads, including a representative attention head 1516. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1508 concatenates the output results of the attention component's separate attention heads, and then multiplies the results of this concatenation by another weight matrix W^{Q}.

The add-and-normalize component 1510 includes a residual connection that combines (e.g., sums) input information fed to the attention component 1508 with the output information generated by the attention component 1508. The add-and-normalize component 1510 then normalizes the output information generated by the residual connection, e.g., by layer-normalizing values in the output information based on the mean and standard deviation of those values, or by performing root-mean-squared normalization. The other add-and-normalize component 1514 performs the same functions as the first-mentioned add-and-normalize component 1510. The FFN component 1512 transforms input information to output information using a feed-forward neural network having any number of layers.

The first transformer component 1504 produces output information 1518. A series of other transformer components (1520, . . . , 1522) perform the same functions as the first transformer component 1504, each operating on output information produced by its immediately preceding transformer component. Each transformer component uses its own level-specific set of machine-trained weights. The final transformer component 1522 in the language model 1502 produces final output information 1524.

In some implementations, a post-processing component 1526 performs post-processing operations on the final output information 1524. For example, the post-processing component 1526 performs a machine-trained linear transformation on the final output information 1524, and processes the results of this transformation using a Softmax component (not shown). The language model 1502 uses the output of the post-processing component 1526 to predict the next token in the input sequence of tokens. In some applications, the language model 1502 performs this task using a greedy selection approach (e.g., by selecting the token having the highest probability), or by using the beam search algorithm (e.g., by traversing a tree that expresses a search space of candidate next tokens). This autoregressive manner of operation is specifically used for each of the computer-implemented agents in the example-generating system 126.

In other implementations, the post-processing component 1526 represents a classification component that produces a classification result. In some implementations, the classification component is implemented by using a fully-connected feed-forward neural network having one or more layers followed by a Softmax component. This manner of operation is appropriate to the classification functions performed by the retrieval model 130 and the relevance model 132.

The loop 1528 indicates the how the language model 1502 operates in the autoregressive mode. As shown, the language model 1502 appends a predicted token to the end of the sequence of input tokens, to provide an updated sequence of tokens. The predicted token leads to the production of a new position-supplemented vector 1530. In a next pass, the language model 1502 processes the updated sequence of position-supplemented vectors to generate a next predicted token. The language model 1502 repeats the above process until it generates a specified stop token.

The above-described implementation of the language model 1502 relies on a decoder-only architecture. Other implementations of the language model 1502 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

Other implementations of the language model 1502 use other kinds of machine-trained models besides, or in addition to, the particular transformer-based architecture shown in FIG. 15. The other machine-trained models include any of convolutional neural networks (CNNs), recurrent neural networks (RNNs), fully-connected feed-forward neural networks (FFNS), stable diffusion models, etc., or any combination thereof.

### E. Illustrative Computing Functionality

FIG. 16 shows computing equipment 1602 that, in some implementations, is used to implement the EGT system 102 and the matching model 104 itself. The computing equipment 1602 includes a set of local devices 1604 coupled to a set of servers 1606 via a computer network 1608. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1608 is implemented as a local area network, a wide area network (e.g., the Internet), one or more point-to-point links, or any combination thereof.

The bottom-most overlapping box in FIG. 16 indicates that the functionality of the EGT system 102 and the machine-trained matching model 104 is capable of being spread across the local devices 1604 and/or the servers 1606 in any manner. In one example, the EGT system 102 is entirely implemented by a local device. In another example, the functions of the EGT system 102 are entirely implemented by the servers 1606. Here, a user is able to interact with the servers 1606 via a browser application running on a local device. In other examples, some of the functions of the EGT system 102 are implemented by a local device, and other functions of the EGT system 102 are implemented by the servers 1606. In some implementations, for instance, the language model(s) are implemented by the servers 1606 and the control system 202 is implemented by one or more local devices. The same applies to the matching model 104 itself, meaning that it can be entirely implemented by local resources, entirely implemented by server-side resources, or implemented by a combination of local and server-side resources.

FIG. 17 shows a computing system 1702 that, in some implementations, is used to implement any aspect of the mechanisms set forth in the above-described figures. For instance, in some implementations, the type of computing system 1702 shown in FIG. 17 is used to implement any local computing device or any server shown in FIG. 16. In all cases, the computing system 1702 represents a physical and tangible processing mechanism.

The computing system 1702 includes a processing system 1704 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1702 also includes computer-readable storage media 1706, corresponding to one or more computer-readable media hardware units. The computer-readable storage media 1706 retains any kind of information 1708, such as machine-readable instructions, settings, model weights, and/or other data. In some implementations, the computer-readable storage media 1706 includes one or more solid-state devices, one or more hard disks, one or more optical disks, etc. Any instance of the computer-readable storage media 1706 represents a fixed or removable unit of the computing system 1702. Further, any instance of the computer-readable storage media 1706 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1702 utilizes any instance of the computer-readable storage media 1706 in different ways. For example, in some implementations, any instance of the computer-readable storage media 1706 represents a hardware memory unit (such as random access memory (RAM)) for storing information during execution of a program by the computing system 1702, and/or a hardware storage unit (such as a hard disk) for retaining/archiving information on a more permanent basis. In the latter case, the computing system 1702 also includes one or more drive mechanisms 1710 (such as a hard drive mechanism) for storing and retrieving information from an instance of the computer-readable storage media 1706.

In some implementations, the computing system 1702 performs any of the functions described above when the processing system 1704 executes computer-readable instructions stored in any instance of the computer-readable storage media 1706. For instance, in some implementations, the computing system 1702 carries out computer-readable instructions to perform each block of the processes described with reference to FIGS. 13 and 14. FIG. 17 generally indicates that hardware logic circuitry 1712 includes any combination of the processing system 1704 and the computer-readable storage media 1706.

In addition, or alternatively, the processing system 1704 includes one or more other configurable logic units that perform operations using a collection of logic gates, such as field-programmable gate arrays (FPGAs), etc. In these implementations, the processing system 1704 effectively incorporates a storage device that stores computer-readable instructions, insofar as the configurable logic units are configured to execute the instructions and therefore embody or store these instructions.

In some cases (e.g., in the case in which the computing system 1702 represents a user computing device), the computing system 1702 also includes an input/output interface 1714 for receiving various inputs (via input devices 1716), and for providing various outputs (via output devices 1718). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1720 and an associated graphical user interface presentation (GUI) 1722. The display device 1720 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1702 also includes one or more network interfaces 1724 for exchanging data with other devices via one or more communication conduits 1726. One or more communication buses 1728 communicatively couple the above-described units together.

The communication conduit(s) 1726 is implemented in any manner, e.g., by a local area computer network, a wide area computer network (e.g., the Internet), point-to-point connections, or any combination thereof. The communication conduit(s) 1726 include any combination of hardwired links, wireless links, routers, gateway functionality, name servers, etc., governed by any protocol or combination of protocols.

FIG. 17 shows the computing system 1702 as being composed of a discrete collection of separate units. In some cases, the collection of units corresponds to discrete hardware units provided in a computing device chassis having any form factor. FIG. 17 shows illustrative form factors in its bottom portion. In other cases, the computing system 1702 includes a hardware logic unit that integrates the functions of two or more of the units shown in FIG. 17. For instance, in some implementations, the computing system 1702 includes a system on a chip (SoC or SOC), corresponding to an integrated circuit that combines the functions of two or more of the units shown in FIG. 17.

The following summary provides a set of illustrative examples of the technology set forth herein.
(A1) According to one aspect, a method (e.g., the process 1402) is described for training a machine-trained matching model (e.g., the match model 104). The method includes: receiving (e.g., in block 1404) initial pairs of queries and identified items, a particular initial pair being an example of an error made by a current version of the machine-trained matching model in pairing a particular submitted query with a particular item; annotating (e.g., in block 1406) the initial pairs with annotations using an annotation computer-implemented agent (e.g., the annotation agent 112), to provide annotated pairs, an explanation for the particular initial pair specifying a reason why the particular submitted query fails to match the particular identified item; clustering (e.g., in block 1408) the annotated pairs into categories using a clustering computer-implemented agent (e.g., the clustering agent 116); generating (e.g., in block 1410 additional examples of query-item mismatches based on the categories, using an example-generating computer-implemented agent (e.g., the example-generating agent 120); and training (e.g., in block 1412) the machine-trained matching model based on at least the additional examples, the training including generating loss information, and updating parameters of the machine-trained matching model using back propagation through layers of the machine-trained matching model based on the loss information.
(A2) According to some implementations of the method of A1, the identified items in the initial pairs are keywords that have been identified as matching the queries by the current version of the machine-trained matching model.
(A3) According to some implementations of the methods of A1 or A2, the categories identify errors made by the current version of the machine-trained matching model in identifying entities associated with the queries of the initial pairs.
(A4) According to some implementations of any of the methods of A1-A3, the clustering includes refining the categories over plural iterations, the refining including merging any pair of categories that are determined to pertain to a same category.
(A5) According to some implementations of any of the methods of A1-A4, the generating additional examples also includes identifying, using a re-ranking machine-trained computer-implemented agent, a set of query-item pairs that match the categories, given a set of input queries.
(A6) According to some implementations of any of the methods of A1-A5, wherein a search engine uses the machine-trained matching model that has been trained to match queries received by the search engine with candidate keywords.
(A7) According to some implementations of the method of A6, the search engine processes a search engine query by: identifying one or more candidate keywords that match the search engine query; identifying, using the machine-trained matching model, one or more output items that match the one or more candidate keywords; and generating output information that identifies the one or more output items.
(A8) According to some implementations of the method of A7, the one or more output items are one or more sponsored search result items, and wherein the output information is a search results user interface presentation that includes the one or more sponsored search result items.
(A9) According to some implementations of any of the methods of A6-A9, the machine-trained matching model includes a machine-trained retrieval model that identifies the candidate keywords that match the queries that are received by the search engine, and wherein the training includes training the machine-trained retrieval model based on the additional examples.
(A10) According to some implementations of the method of A9, the machine-trained matching model also includes a machine-trained relevance model that filters the candidate keywords for relevance to the queries that are received by the search engine, and wherein the training also includes training the machine-trained relevance model based on the additional examples.
(A11) According to some implementations of any of the methods of A1-A10, wherein the annotation computer-implemented agent, the clustering computer-implemented agent, and the example-generating computer-implemented agent are implemented by one or more machine-trained models.
(A12) According to some implementations of the method of A11, the one or more machine-trained models are one or more language models.
(A13) According to some implementations of any of the methods of A1-A12, wherein the annotation computer-implemented agent, the clustering computer-implemented agent, and the example-generating computer-implemented agent are each accessed through an application programming interface.

In yet another aspect, some implementations of the technology described herein include a computing system (e.g., the computing system 1702) that includes a processing system (e.g., the processing system 1704) having a processor. The computing system also includes a storage device (e.g., the computer-readable storage media 1706) for storing computer-readable instructions (e.g., the information 1708). The processing system executes the computer-readable instructions to perform any of the methods described herein (e.g., any individual method of the methods of A1-A13).

In yet another aspect, some implementations of the technology described herein include a computer-readable storage medium (e.g., the computer-readable storage media 1706) for storing computer-readable instructions (e.g., the information 1708). A processing system (e.g., the processing system 1704) executes the computer-readable instructions to perform any of the methods described herein (e.g., any individual method of the methods of A1-A13).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, in some examples, the phrase “configured to” encompasses various physical and tangible mechanisms for performing an identified operation. The mechanisms are configurable to perform an operation using the hardware logic circuitry 1712 of FIG. 17. In some examples, the term “logic” likewise encompasses various physical and tangible mechanisms for performing a task. For instance, each processing-related operation illustrated in the flowcharts of FIGS. 13 and 14 corresponds to a logic component for performing that operation.

Further, in some examples, the term “plurality” or “plural” or the plural form of any term (without explicit use of “plurality” or “plural”) refers to two or more items, and does not necessarily imply “all” items of a particular kind, unless otherwise explicitly specified. In some examples, the term “at least one of” refers to one or more items; reference to a single item, without explicit recitation of “at least one of” or the like, is not intended to preclude the inclusion of plural items, unless otherwise noted. Further, in some examples, the descriptors “first,” “second,” “third,” etc. are used to distinguish among different items, and do not imply an ordering among items, unless otherwise noted. In some examples, the phrase “A and/or B” means A, or B, or A and B. In some examples, the phrase “any combination thereof” refers to any combination of two or more elements in a list of elements. Further, in some examples, the terms “comprising,” “including,” and “having” are open-ended terms that are used to identify at least one part of a larger whole, but not necessarily all parts of the whole. In some examples, a “set” is a group that includes one or more members. In some examples, the phrase “A corresponds to B” means “A is B” in some contexts. In some examples, the term “prescribed” is used to designate that something is purposely chosen according to any environment-specific considerations. For instance, a threshold value or state is said to be prescribed insofar as it is purposely chosen to achieve a desired result. In some examples, “environment-specific” means that a state is chosen for use in a particular environment. Finally, in some examples, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for training a machine-trained matching model, comprising:
receiving initial pairs of queries and identified items, a particular initial pair being an example of an error made by a current version of the machine-trained matching model in pairing a particular submitted query with a particular item;
annotating the initial pairs with annotations using an annotation computer-implemented agent, to provide annotated pairs, an explanation for the particular initial pair specifying a reason why the particular submitted query fails to match the particular identified item;
clustering the annotated pairs into categories using a clustering computer-implemented agent;
generating additional examples of query-item mismatches based on the categories, using an example-generating computer-implemented agent; and
training the machine-trained matching model based on at least the additional examples, the training including generating loss information, and updating parameters of the machine-trained matching model using back propagation through layers of the machine-trained matching model based on the loss information.

2. The method of claim 1, wherein the identified items in the initial pairs are keywords that have been identified as matching the queries by the current version of the machine-trained matching model.

3. The method of claim 1, wherein the categories identify errors made by the current version of the machine-trained matching model in identifying entities associated with the queries of the initial pairs.

4. The method of claim 1, wherein the clustering includes refining the categories over plural iterations, the refining including merging any pair of categories that are determined to pertain to a same category.

5. The method of claim 1, wherein the generating additional examples also includes identifying, using a re-ranking machine-trained computer-implemented agent, a set of query-item pairs that match the categories, given a set of input queries.

6. The method of claim 1, wherein a search engine uses the machine-trained matching model that has been trained to match queries received by the search engine with candidate keywords.

7. The method of claim 6, wherein the search engine processes a search engine query by:
identifying one or more candidate keywords that match the search engine query;
identifying, using the machine-trained matching model, one or more output items that match the one or more candidate keywords; and
generating output information that identifies the one or more output items.

8. The method of claim 7, wherein the one or more output items are one or more sponsored search result items, and wherein the output information is a search results user interface presentation that includes the one or more sponsored search result items.

9. The method of claim 6, wherein the machine-trained matching model includes a machine-trained retrieval model that identifies the candidate keywords that match the queries that are received by the search engine, and wherein the training includes training the machine-trained retrieval model based on the additional examples.

10. The method of claim 9, wherein the machine-trained matching model also includes a machine-trained relevance model that filters the candidate keywords for relevance to the queries that are received by the search engine, and wherein the training also includes training the machine-trained relevance model based on the additional examples.

11. The method of claim 1, wherein the annotation computer-implemented agent, the clustering computer-implemented agent, and the example-generating computer-implemented agent are implemented by one or more machine-trained models.

12. The method of claim 11, wherein the one or more machine-trained models are one or more language models.

13. The method of claim 1, wherein the annotation computer-implemented agent, the clustering computer-implemented agent, and the example-generating computer-implemented agent are each accessed through an application programming interface.

14. A computing system for use in a search engine, comprising:
an instruction data store for storing computer-readable instructions; and
a processing system for executing the computer-readable instructions in the data store, to perform operations including:
receiving a search engine query;
identifying, using a machine-trained matching model, one or more candidate keywords that match the search engine query;
identifying one or more output items that match the one or more candidate keywords; and
generating output information that identifies the one or more output items,
wherein the machine-trained matching model has been trained by:
receiving initial pairs of queries and identified keywords, a particular initial pair being an example of an error made by a current version of the machine-trained matching model in pairing a particular submitted query with a particular keyword;
annotating the initial pairs with annotations using an annotation computer-implemented agent, to provide annotated pairs, an explanation for the particular initial pair specifying a reason why the particular submitted query fails to match the particular keyword;
clustering the annotated pairs into categories using a clustering computer-implemented agent;
generating additional examples of query-item mismatches based on the categories, using an example-generating computer-implemented agent; and
training the machine-trained matching model based on at least the additional examples, wherein the training includes generating loss information, and updating parameters of the machine-trained matching model using back propagation through layers of the machine-trained matching model based on the loss information.

15. The computing system of claim 14, wherein the one or output target items are one or more sponsored search result items, and wherein the output information is a search results user interface presentation that includes the one or more sponsored search result items.

16. The computing system of claim 14, wherein the machine-trained matching model includes a machine-trained retrieval model that identifies the one or more candidate keywords that match the search engine query, wherein the training includes training the machine-trained retrieval model based on the additional training examples, and wherein, in training the machine-trained retrieval model, the additional training examples are interpreted as hard negatives.

17. The computing system of claim 16, wherein the machine-trained matching model also includes a machine-trained relevance model that filters the one or more candidate keywords for relevance to the search engine query, wherein the training also includes training the machine-trained relevance model based on the additional training examples, and wherein, in training the machine-trained relevance model, the additional training examples are interpreted as negatives.

18. A computer-readable storage medium for storing computer-readable instructions, a processing system executing the computer-readable instructions to perform operations, the operations comprising:
receiving initial pairs of queries and identified items, a particular initial pair being an example of an error made by a current version of a machine-trained matching model in pairing a particular submitted query with a particular item;
annotating the initial pairs with annotations using a machine-trained annotation model, to provide annotated pairs, an explanation for the particular initial pair specifying a reason why the particular submitted query fails to match the particular identified item;
clustering the annotated pairs into categories using a machine-trained clustering model;
generating additional examples of query-item mismatches based on the categories, using a machine-trained example-generating model,
wherein the generating additional examples also includes identifying, using a machine-trained ranking model, a set of query-item pairs that match the categories; and
training the machine-trained matching model based on at least the additional examples, wherein the training includes generating loss information, and updating parameters of the machine-trained matching model using back propagation through layers of the machine-trained matching model based on the loss information.

19. The computer-readable storage medium of claim 18, wherein the identified items in the initial pairs are keywords that have been identified as matching the queries by the current version of the machine-trained matching model.

20. The computer-readable storage medium of claim 18, wherein the categories identify errors made by the current version of machine-trained matching model in identifying entities associated with the queries of the initial pairs.
